(19) United States
(12) Patent Application Publication
(10) Pub. No.: US 2012/0164491 A1
(43) Pub. Date: Jun. 28, 2012

(54) GALVANIC CELL HAVING RELEASABLE CONNECTING AREA

(75) Inventors: Tim Schaefer, Niedersachswerfen (DE); Andreas Gutsch, Luedinghausen (DE)

(73) Assignee: LI-TEC BATTERY GMBH, Kamenz (DE)

(21) Appl. No.: 13/260,953

(22) PCT Filed: Feb. 10, 2010
(86) PCT No.: PCT/EP2010/000819

§ 371 Date: Mar. 14, 2012

(30) Foreign Application Priority Data
Mar. 31, 2009 (DE) 10 2009 015 687.9

(51) Int. Cl. H01M 10/42; H01M 2/02; H01M 2/30; H01M 10/50; H01M 2/20; H01M 2/16; H01M 10/04; H01M 10/48; B82Y 30/00

(52) U.S. Cl. 429/50; 429/163; 429/185; 429/61; 977/773

(57) ABSTRACT

The invention relates to a galvanic cell (1) comprising a substantially prismatic electrode stack (6), an electrolyte, and a housing. The housing is provided in order to at least partially enclose the electrode stack. The electrode stack is designed having multiple layers, and comprises at least one anode layer (2), a cathode layer (3), and a separator (4). The separator layer (4) is disposed at least partially between the anode layer (2) and the cathode layer (3). The separator layer (4) at least partially absorbs the electrolyte. The at least one anode layer (2), the at least one cathode layer (3), and the at least one separator layer (4) are provided in order to be releaseably connected to each other in at least one connecting area, particularly by means of at least one releasable connecting device.

Priority application DE 10 2009 015 687.9 is fully incorporated by reference into the present application.

The invention relates to a galvanic cell according to the preamble of the claim 1. The invention is described in connection with a lithium-ion battery for supplying a motor vehicle. It should be noted that the invention can be used independently of the chemistry of the galvanic cell, the design of the galvanic cell or the type of the drive to be supplied.

From the prior art, galvanic cells are known which, for example in case of mechanical damage or in case of overheat, can possibly release stored energy in an uncontrolled manner. This can endanger the environment.

It is the object of the invention to make a galvanic cell safer.

This object is solved by a galvanic cell with the features of the claim 1. Preferred and advantageous further developments are subject matter of the dependent claims. A preferred use of the galvanic cell according to the invention is subject matter of an independent claim.

A galvanic cell according to the invention comprises a substantially prismatic electrode stack, an electrolyte and a housing. The housing is provided in order to at least partially enclose the electrode stack. The electrode stack is designed having multiple layers and comprises at least one anode layer, one cathode layer and one separator layer.

The at least one separator layer is arranged at least partially between an anode layer and a cathode layer. The at least one separator layer at least partially absorbs the electrolyte. The at least one anode layer, the at least one cathode layer and the at least one separator layer are provided in order to be releasably connected to each other in at least one connecting area, in particular by means of at least one connecting device.

In the meaning of the invention, a galvanic cell is to be understood as a device which also serves for storing chemical energy and releasing electrical energy. For this purpose, the galvanic cell according to the invention has an electrode stack and an electrolyte. Also, the galvanic cell can be configured to hold electrical energy during charging. This is also called secondary cell or accumulator.

In the meaning of the invention, an electrode stack is to be understood as a device which, as sub-assembly of a galvanic cell, also serves for storing chemical energy and for releasing electrical energy. Prior to releasing electrical energy, stored chemical energy is converted into electrical energy. During the charging, the electrical energy fed to the electrode stack or the galvanic cell is converted into chemical energy and stored. For this purpose, the electrode stack has a plurality of layers, at least one anode electrode, one cathode electrode and one separator layer. The layers are laid on top of each other or stacked, wherein the separator layer is at least partially arranged between an anode layer and a cathode layer. Preferably, this sequence of the layers is repeated several times within the electrode stack. Preferably, some electrodes are in particular electrically interconnected, in particular connected in parallel. Preferably, the layers are wound into an electrode coil. In the following, the term “electrode stack” is also used for electrode coils.

In the meaning of the invention, an anode electrode or an anode is to be understood as a device which receives electrons during charging and/or stores positively charged interstitial ions. Preferably, the anode is thin-walled; particularly preferred, the thickness of the anode is less than 5% of its outer circumference. Preferably, the anode comprises a metal film or a metallic net structure. Preferably, the anode is formed in a substantially rectangular manner.

In the meaning of the invention, a cathode electrode or a cathode is to be understood as a device which during discharging or releasing electrical energy also receives electrons and positively charged ions. Preferably, the cathode is thin-walled; particularly preferred, the thickness of the cathode is less than 5% of its outer circumference. Preferably, the cathode comprises a metal film or a metallic net structure. Preferably, the shape of a cathode corresponds substantially to the shape of an electrode stack. The cathode is also provided for electrochemically interacting with the anode or the electrolyte.

In the meaning of the invention, a separator layer or a separator is also to be understood as an electrically insulating apparatus which separates an anode from a cathode and spaces them apart. Preferably, a separator layer is applied onto an anode layer and/or a cathode layer. Also, the separator layer or the separator at least partially absorbs an electrolyte, wherein the electrolyte preferably contains lithium-ions. The electrolyte is also electrochemically connected in an operative manner to adjacent layers of the electrode stack. Preferably, the shape of a separator corresponds substantially to the shape of an anode of the electrode stack. Preferably, a separator layer or a separator extends at least in certain areas over a boundary edge of at least one in particular adjacent electrode. Particularly preferred, the separator layer or a separator extends beyond all boundary edges of in particular adjacent electrodes.

In the meaning of the invention, a housing is to be understood as a device which also separates the electrode stack from the environment. For this purpose, the housing or a casing encloses the electrode stack substantially completely with a wall. This does not exclude that different electrode stacks or galvanic cells in particular of a superordinated battery are separately enclosed or sealed. Preferably, the housing is firmly bonded with the electrode stack at least in certain areas. Preferably, the housing is formed as composite film. Preferably, the housing is formed from at least two bodies which are in particular firmly bonded to each other about the electrode stack. The at least two bodies are geometrically adapted to each other. Preferably, at least one of the at least two bodies comprises at least one electrically conductive material, in particular a metal.

In the meaning of the invention, a connecting area is to be understood as an area in which a layer of the electrode stack is releasably connected to at least one further layer, in particular an adjacent layer. Preferably, a plurality connecting areas coincide at least partially. Preferably, adjacent layers within a connecting area are releasably connected to each other in particular in a firmly bonded and/or force-fitted manner. Preferably, a releasable connecting area is arranged in an edge area and/or along a boundary edge of a layer of the electrode stack. Preferably, adjacent layers of the electrode stack have a plurality of connecting areas.

In the meaning of the invention, a connecting device is to be understood as a device which is provided to releasably connect at least two adjacent layers of the electrode stack in a connecting area. Preferably, different releasable connecting areas are in each case associated with one connecting device. Preferably, a plurality of releasable connecting areas of two adjacent layers of the electrode stack is associated with one common releasable connecting device. Preferably, a connecting device is taken from the following group of devices which comprises in particular stapling devices, staples, tacking threads, adhesive dots, adhesive strips, clamping devices, clamps, tapes, circumferential belts, also made from fabrics.

With increasing temperature of an area of the electrode stack of a galvanic cell, the activity of the electrolyte is increased there as well. Thus, this area of an electrode stack can supply or draw an increased electric current. Said increased electric current effects an increased heat output since the resistance of the respective electric conductor increases with the temperature. Thus, the temperature increase of the area involved of a galvanic cell is enhanced. This interaction can result in an ignition of the galvanic cell.

In contrast, a galvanic cell according to the invention is characterized in that at least one releasable connecting area or releasable connecting device fails. According to the invention, adjacent layers of the electrode stack move away from each other at least in certain areas. The electrochemical interaction between these areas spaced apart from each other is reduced or disabled. A further temperature increase or an uncontrolled release of stored energy is advantageously prevented. Therefore, the underlying object is solved.

Further embodiments of the invention which are to be preferred are described below.

Advantageously, the housing rests largely against the electrode stack. Preferably, the housing at least partially encloses the electrode stack in a form-fitting manner, supports the electrode stack and holds the individual layers of the latter together. Preferably, the housing is pretensioned and forces the layers of the electrode stack against each other. Here, the housing acts in particular as releasable connecting device. Preferably, the housing is formed from a material which fails at predetermined conditions, in particular softens, breaks and/or becomes permeable. Preferably, the housing has at least one connecting seam which fails at least partially at predetermined conditions, in particular if a temperature and/or pressure is exceeded. After softening of the material or at least partial destruction of the housing or a connecting seam, the compressive action of the housing on the electrode stack is reduced. Thus, at least partially releasable connecting areas are released and in particular the electrochemical interaction within the electrode stack is reduced. Preferably, the housing is formed with at least one thin region which fails at predetermined conditions, in particular if a temperature and/or pressure is exceeded. In a sealing area, the housing is connected in certain areas to the electrode stack, in particular in a firmly bonded manner. Preferably, the sealing area is adapted to the load resulting from the operation of the galvanic cell, in particular to occurring shear stresses. Preferably, the sealing area is partially thinned and has a predetermined breaking point. Preferably, an additive is added to the electrolyte, which additive softens the housing and/or the sealing area at predetermined conditions or reduces the tightness. Preferably, above a predetermined temperature, the electrolyte or the additive releases a reactive component, in particular HF. The reactive component is in particular provided to destroy the housing at least partially by chemical effect. Preferably, the reactive component penetrates the housing, softens it and/or makes it permeable. Preferably, the at least one opening device is formed as a feeder from a thermally deformable material or composite material. Said composite material preferably has areas of different thermal expansion. Thus, a feeder from a composite material changes its shape depending on a temperature change. Depending on the shape of the feeder, the latter preferably exerts a force onto the housing, which force at least partially destroys in particular the housing. Said feeder preferably has sharp-edged or pointed elements which destroy or penetrate the housing above a predetermined temperature. Preferably, this feeder is made from a material which, as a result of a chemical reaction with a reactive component, in particular in presence of a gas, dissolves or bends thereby creating an opening.

Advantageously, the at least one releasable connecting area or the at least one releasable connecting device fails at predetermined conditions, in particular if a predetermined pressure and/or a predetermined temperature is exceeded. Preferably, a firmly bonded and/or form-fitting connection fails by softening and/or deforming at least one of the layers involved. Preferably, a stapling device or a clamping device comprises a material which softens and/or fails at predetermined conditions, in particular above a predetermined temperature. Preferably, a clamping device comprises a component from a material which, at predetermined conditions, in particular above a predetermined temperature, loses its strength. Preferably, a clamping device is spring-loaded.

Advantageously, the releasable connecting device is associated with the housing. Preferably, the at least one releasable connecting device is connected to the housing. Preferably, the at least one releasable connecting device is connected to the housing in an articulated manner. Preferably, the at least one releasable connecting device is spring-loaded. Preferably, the at least one releasable connecting device is associated with an opening device. In this manner, the electrode stack is protected in particular against undesired displacement within the housing.

Advantageously, the at least one releasable connecting device has at least one terminal contact which serves in particular for electrically contacting the electrode stack. Advantageously, the at least one releasable connecting device has at least two areas which are electrically insulated from each other and are operatively connected to electrodes of different polarity. Preferably, each of these areas of a releasable connecting device has its own terminal contact for electrically contacting the electrode stack. If a releasable connecting device opens up, according to the invention, in particular contacting the electrode stack is at least partially interrupted. Preferably, after opening a releasable connecting device, at least one connecting area becomes released and the associated layers move at least partially away from each other. Preferably, at least one terminal contact is guided through the wall of the housing and is at least in electrical contact outside of the housing. Preferably, a releasable connecting device has at least one frame element. Preferably, said frame element forms a portion of the wall of the housing.

Preferably, the housing is associated with at least one opening device. The latter is provided for opening the housing at predetermined conditions, in particular above a predetermined temperature and/or a predetermined pressure. According to the invention, opening the housing or a connecting seam of the housing causes in particular a release of at least one connecting area. Associated layers of the electrode stack move away from each other at least in certain areas and their electrochemical interaction is at least reduced. The opening device is preferably configured so as to open the housing without external actuation. Preferably, the at least one opening device is part of the housing. Preferably, the at least one opening device has a pointed and/or sharp-edged geometry. Preferably, the opening device is arranged in such a manner that it breaks through or opens the wall of the housing at a predetermined deformation. Preferably, the at least one opening device is formed as blade or needle, in particular as hollow needle. Preferably, a fluid is conveyed through said hollow needle into a space or location provided for this purpose inside the housing. Preferably, the at least one opening device is configured as overpressure valve. Preferably, the at least one opening device is associated with an actuator, wherein the actuator is actuated by a mechanism, a battery management system and/or an control device. Preferably, the actuator is part of the opening device. Preferably, the actuator is driven by an electric pulse, mechanical, electrical and/or other energy. Preferably the at least one opening device opens the housing as soon as a temperature of 60° C. is exceeded in particular on the surface of the housing. Preferably, the opening device is arranged in such a manner that a substance escaping after opening the housing is fed to the cooling system of the vehicle and/or to a space, in particular a condensation cartridge, provided for this purpose. Preferably, the condensation cartridge is replaceable during maintenance work. Preferably, the housing has a plurality of opening devices which open the housing at different conditions. Thus, with increasing pressure and/or temperature, further opening devices can generate additional openings of the housing. Preferably, the housing is provided with a predetermined breaking point which is arranged in particular in the sealing area. Preferably, the housing or the sealing area is thinned in the area of the predetermined breaking point. Preferably, for setting a certain breaking load, the sealing area is treated with electromagnetic radiation, thermally and/or mechanically weakened, in particular after the generation of the sealing area. Preferably, at least one further material is inserted between housing and electrode stack prior to the generation of the sealing area or is fastened on the outside of the generated sealing area.

This further material is provided in order to become weakened at predetermined conditions by a chemical in particular from inside the housing and/or to change its geometry. This chemical is preferably added to the electrode stack. Preferably, a chemical is fed at predetermined conditions into the interior of the housing or the wall thereof by means of an injection needle. This chemical is provided for weakening the material of the housing. Preferably, an opening device is connected to the air conditioning system of the vehicle, wherein substance escaping from the housing is received by the cooling system, in particular the cooling medium of the air conditioning system. Preferably, the substance escaping from the housing is fed to a chamber. Preferably, the substance escaping from the housing is cooled or condensed in said chamber. Preferably, the cooling takes place by means of a heat pipe. Preferably, the chamber for receiving a substance escaping from the housing is configured as condensation cartridge. Preferably, the condensation cartridge is replaced within the maintenance works. Preferably, a plurality of opening devices are connected to a common condensation cartridge. Preferably, an opening device is configured as rotary closure or screw closure. Preferably, an opening device is configured in such a manner that a plug is pressed with a defined force out of a nozzle, wherein the nozzle is part of the housing. Preferably, an opening device is configured as weak point of the housing which has a line-shaped thin region or notch. Preferably, said thin region is engraved into the housing, in particular into the sealing area. Preferably, the opening device has a spring-loaded lever.

Advantageously, the at least one releasable connecting area is formed elongated along at least one boundary edge of the electrode stack. Preferably, the at least one releasable connecting area is formed elongated along a boundary edge of the electrode stack. Preferably, the electrode stack is substantially cuboidal and has four edges which extend substantially parallel to each other and are longer than the remaining boundary edges of the cuboid. Preferably, the at least one connecting area extends along at least one such longer boundary edge. Preferably, at least one releasable connecting device is arranged in such a manner with respect to the electrode stack that the connecting device generates and substantially covers the at least one elongated connecting area. Preferably, the galvanic cell has at least two releasable connecting devices which are arranged along two opposing boundary edges of the electrode stack. The electrode stack then has at least two elongated releasable connecting areas. Preferably, the at least one releasable connecting device is connected to the housing of the galvanic cell. Preferably, at predetermined conditions, the at least one releasable connecting device releases the electrode stack or allows releasing the at least one connecting area.

Advantageously, the galvanic cell is associated with at least one measuring device, in particular for detecting the temperature and/or a pressure of the galvanic cell. The measuring device provides, at least temporarily, a signal which is also intended for being processed by a control device which does not belong to the galvanic cell. Preferably, the galvanic cell has at least one cooling device which, at predetermined conditions, supplies heat energy to the galvanic cell or extracts it therefrom. Preferably, the at least one cooling device is switchable. Preferably, for a switching process of the at least one cooling device, a signal of the at least one measuring device is considered.

Advantageously, the galvanic cell has at least one means for releasing a releasable connecting area or a releasable connecting device. Preferably, such a means is actuated at predetermined conditions, in particular if a predetermined temperature and/or a predetermined pressure is exceeded. Here, the means is taken from the group of means comprising in particular levers, wedges, screws, shaped pieces having a defined breaking load or defined conditions for their softening.

Preferably, said means or shaped pieces are operatively connected to the releasable connecting areas or releasable connecting devices in such a manner that at predetermined conditions at least on releasable connecting area is released.

Advantageously and preferably, a separator is used which consists of a substance-permeable carrier, preferably partially substance-permeable, thus substantially permeable with respect to at least one material and impermeable with respect to at least one other material. The carrier is coated on at least one side with an inorganic material. As substance-permeable carrier, preferably, an organic material is used which preferably is configured as nonwoven fabric. Said organic material, preferably a polymer and particularly preferred polyethylene-terephthalate (PET), is coated with an inorganic ion-conductive material which is preferably ion-conductive in a temperature range of −40° C. to 200° C. The inorganic ion-conductive material preferably comprises at least one compound from the group of oxides, phosphates, sulfates, titanates, silicates, aluminosilicates with one of the elements Zr, Al, Li, particularly preferred zirconium oxide. Preferably, the inorganic ion-conductive material has particles with a largest diameter of less than 100 nm. Such a separator is distributed for example under the trade name “Separion” by the Evonik AG in Germany.

Advantageously, a galvanic cell, the electrodes and separators of which are releasably connected in at least one releasable connecting area is operated in such a manner that upon exceeding a predetermined condition, in particular upon exceeding a temperature and/or a pressure, the at least one releasable connecting area is released. Preferably, a means for releasing the at least one releasable connecting area is used. After releasing the at least one releasable connecting area, at least two layers of the electrode stack move at least partially away from each other. Thus, the electrochemical interaction between these two layers is reduced. After releasing a connecting device, at least two layers of the electrode stack move at least partially away from each other and/or contacting the electrode stack is interrupted.

Advantageously, a galvanic cell having a housing and at least one opening device is operated in such a manner that the at least one opening device opens the housing at predetermined conditions, in particular upon exceeding a predetermined pressure and/or a predetermined temperature. Preferably, a means for actuating the at least one opening device is used here.

Advantageously, a galvanic cell is used for supplying a drive of a motor vehicle having an electric drive or a hybrid drive.

Further advantages, features and possibilities of use of the present invention arise from the following exemplary description in connection with the figures. In the figures:

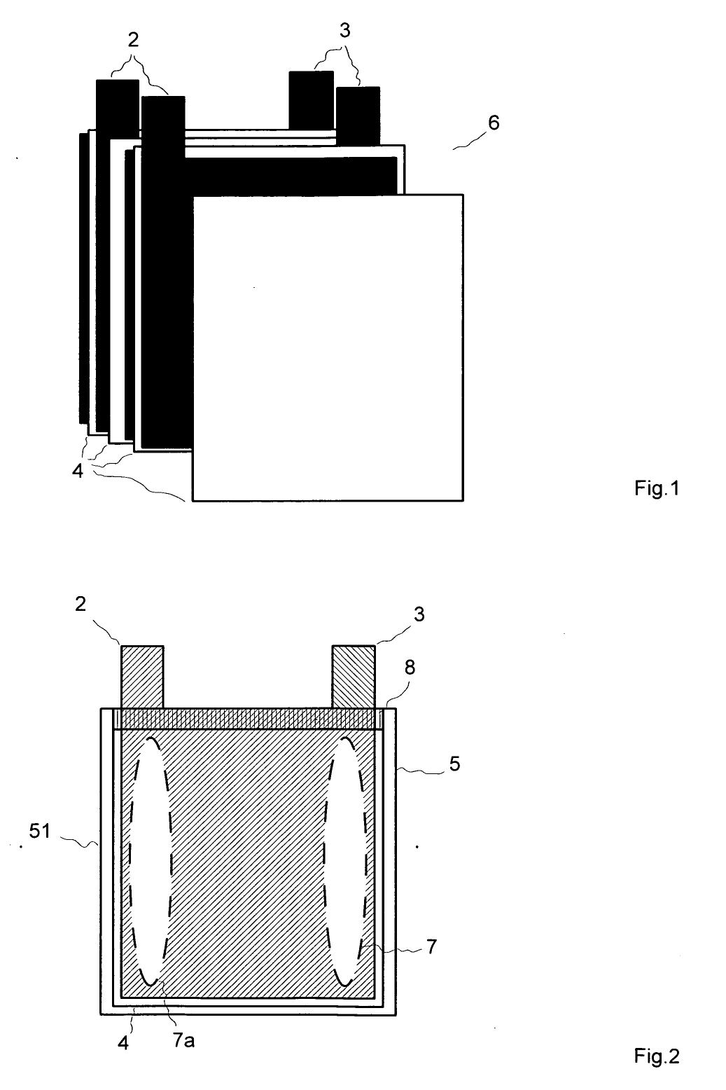

FIG. 1 shows the electrode stack of a galvanic cell according to the invention,

FIG. 2 shows a galvanic cell having releasable connecting areas and a sealing area,

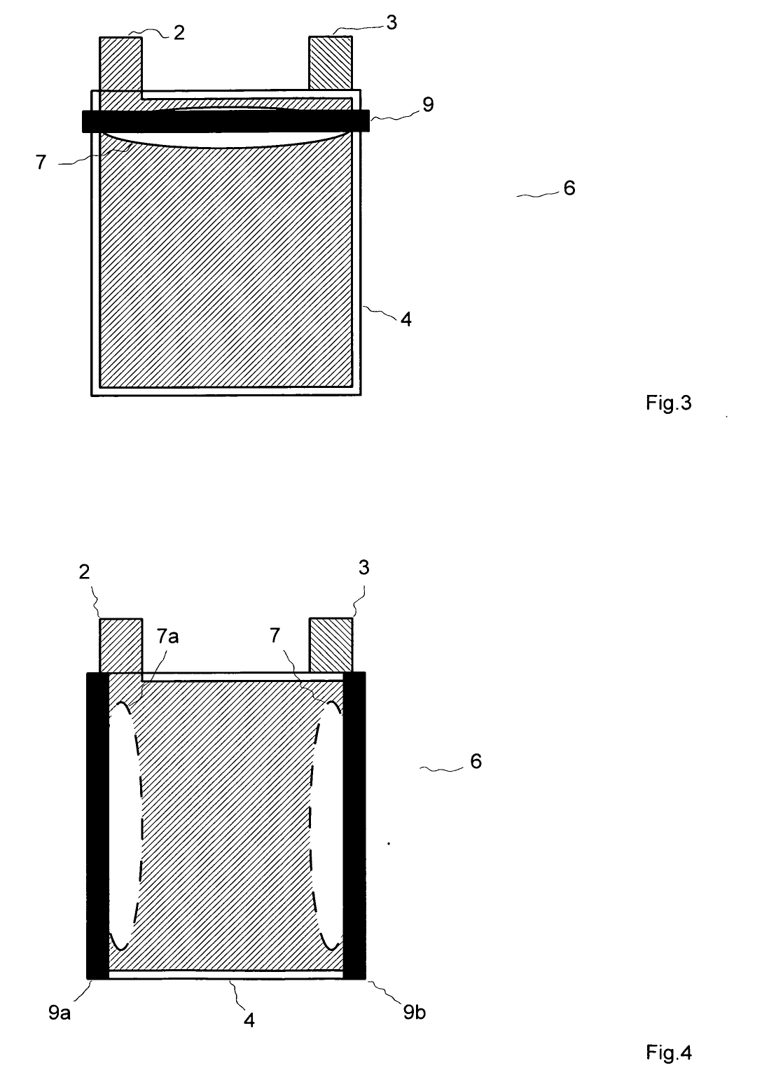

FIG. 3 shows the electrode stack of a further embodiment of a galvanic cell according to the invention having a releasable connecting area,

FIG. 4 shows the electrode stack of a further embodiment of a galvanic cell according to the invention having a plurality of releasable connecting areas,

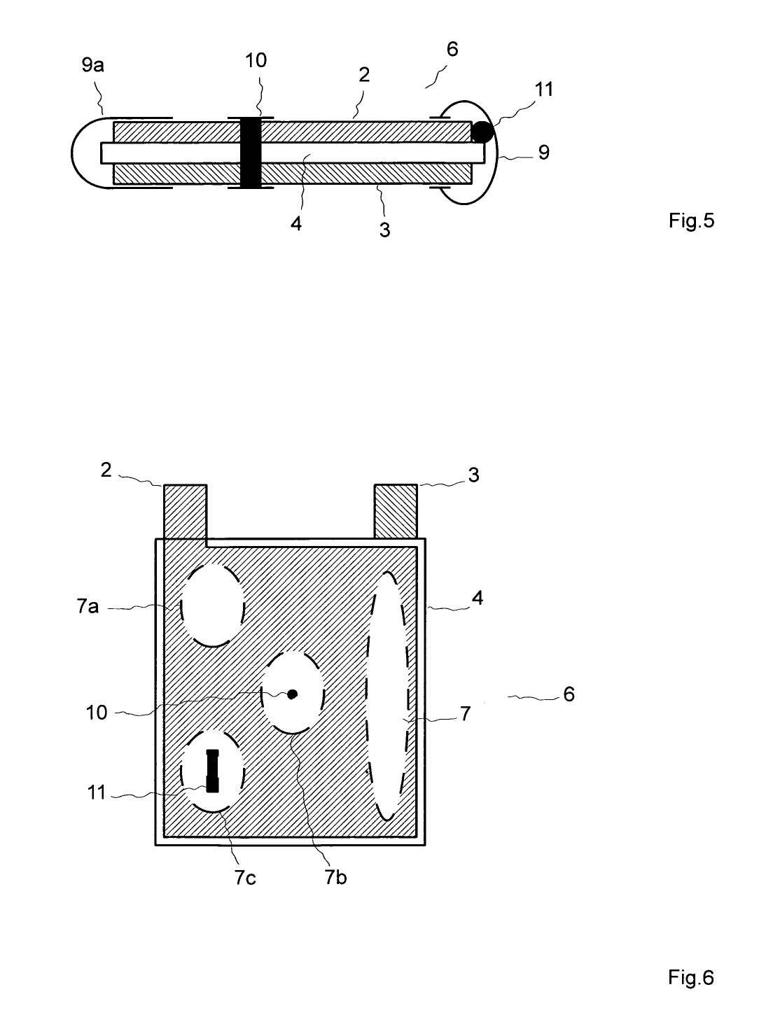

FIG. 5 shows the electrode stack of a further embodiment of a galvanic cell according to the invention having two releasable connecting devices,

FIG. 6 shows the electrode stack of a further embodiment of a galvanic cell according to the invention having different releasable connecting devices,

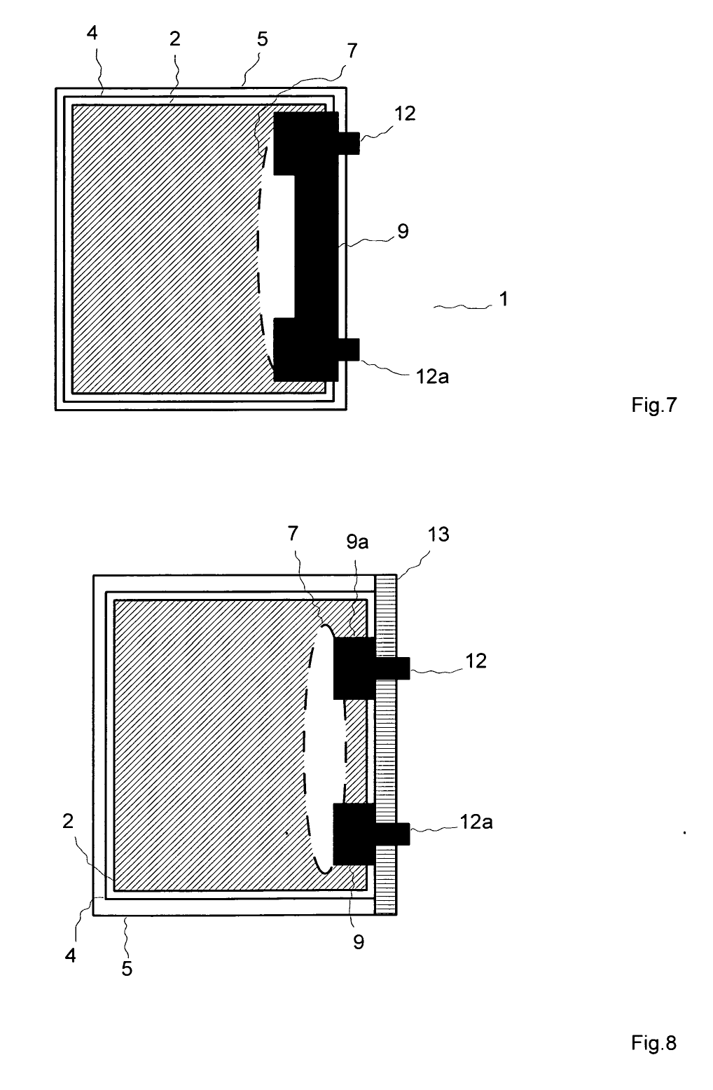

FIG. 7 shows the electrode stack of a further embodiment of a galvanic cell according to the invention having a releasable connecting device with terminal contacts,

FIG. 8 shows the electrode stack of a further embodiment of a galvanic cell according to the invention having two releasable connecting devices and a frame element,

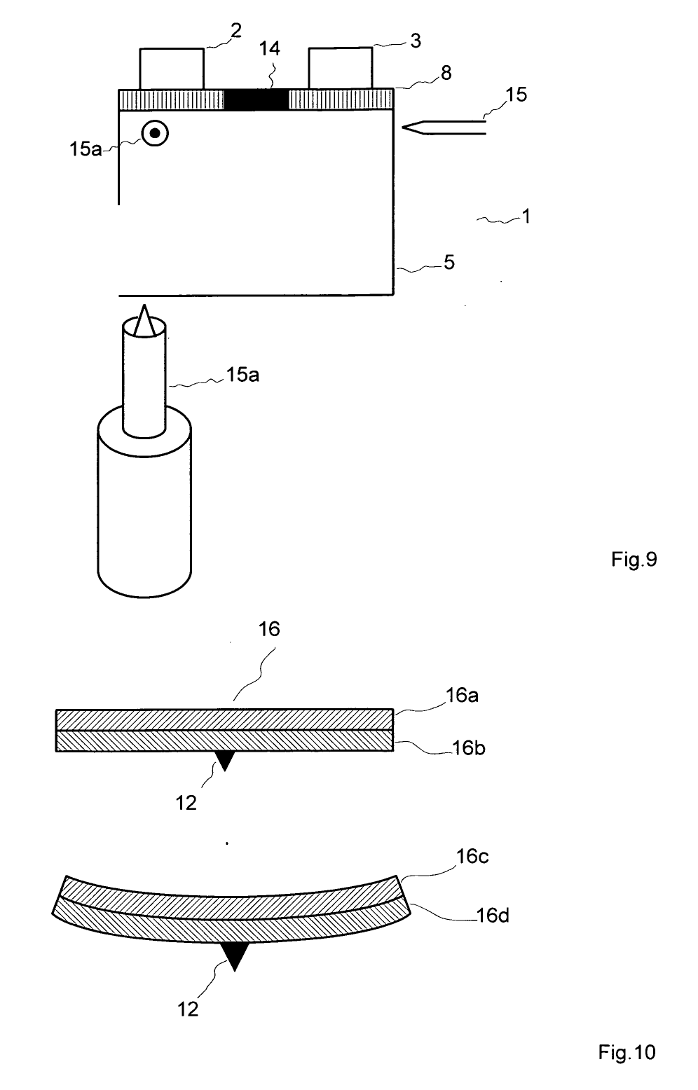

FIG. 9 shows a further embodiment of a galvanic cell according to the invention, and

FIG. 10 shows a feeder for a galvanic cell according to the invention.

Hereinafter, identical or identically acting components or elements are uniformly designated by the same reference numbers.

FIG. 1 shows a fanned out electrode stack 6 comprising a plurality of anode layers 2, a plurality of cathode layers 3 and a plurality of separator layers 4. The separator layers 4 are dimensioned such that they circumferentially protrude the electrode layers 2, 3. The separator layer 4 is wetted with an ionic liquid. It is not illustrated here that the electrode layers of the same polarity are connected to each other in an electrically conductive manner.

FIG. 2 shows a galvanic cell 1 according to the invention having an electrode stack in a housing 5. The electrode stack has an anode 2, a cathode 3 and a separator 4. The different layers are connected in the connecting areas 7, 7a (dashed). The housing 5 is firmly bonded with the electrode stack in a sealing area 8. The housing 5 has a connecting seam 51 which configured such that it fails at predetermined conditions. Prior to generating the sealing area 8, a low pressure is generated inside the housing 5. Thus, the housing rests tightly against the electrode stack and forces the same together. With the connecting seam 51 failing, the compressing action of the housing 5 on the electrode stack is reduced. Subsequently, the connecting area 7a is released and the associated layers of the electrode stack move at least partially away from each other. Thus, the electrochemical interaction between them is at least partially interrupted.

FIG. 3 shows an electrode stack 6 having two electrode layers 2, 3 and a separator layer 4. These layers are connected to the releasable connecting area 7. The connecting area 7 is generated by the circumferentially extending fabric belt 9, wherein the fabric belt 9 softens above a predetermined temperature and in particular stretches noticeably. Subsequently, the connecting area 7 becomes released and the associated layers of the electrode stack move at least partially away from each other. Thus, the electrochemical interaction therebetween is at least partially interrupted.

FIG. 4 shows an electrode stack 6 having two electrode layers 2, 3 and a separator layer 4. These layers are connected in the releasable connecting areas 7, 7a through the clamping rails 9a, 9b. Said clamping rails 9a, 9b are spring-loaded, wherein the springs are not illustrated here. The springs are configured such that their spring constants successively drop with increasing temperature. Thus, with increasing temperature, the clamping rails 9a, 9b become more and more elastic, the connecting areas 7, 7a are increasingly released and the associated layers move at least partially away from each other. The electrochemical interaction of the layers is therefore reduced or disabled.

FIG. 5 shows the electrode stack 6 in a side view. Anode 2 and cathode 3 enclose the separator 4 which extends beyond the surfaces of the electrodes 2, 3. In a plurality of connecting areas (not marked), the rails are connected by means of connecting devices 9, 9a, 10. Further, the electrode stack 6 is associated with a cooling device 11 for dissipating heat which contacts the electrode stack 6 in a heat-conducting manner. The cooling device can have geometries in certain areas for enlarging the surface. With increasing temperature, the clamping devices 9, 9a soften, whereby the connecting areas are released. The electrically non-conductive stapling device 10 is provided at one end with a weak point. An additive is added to the electrolyte. Above a predetermined temperature, the additive has a damaging effect on the material of the stapling device 10. The weak point of the latter preferably fails and releases the associated connecting area. Alternatively, the clamping device 9, 9a is made from a composite material which has areas of different coefficients of expansions, for example a bimetal.

FIG. 6 shows an electrode stack 6 having two electrode layers 2, 3 and a separator layer 4. They are interconnected in the releasable connecting areas 7, 7a, 7b, 7c. The releasable connecting areas 7, 7a are provided with an adhesive which fails above a predetermined temperature. The electrically non-conductive connecting rivet 10 fails above a predetermined temperature. The staple 11 which is electrically non-conductive as well fails due to the damaging effect of an additive of the electrolyte which is released above a predetermined temperature. A tacking thread becomes brittle or breaks due to the effect of heat. A non-illustrated activator exerts a force on the electrode stack so that a band or tacking thread breaks.

FIG. 7 and FIG. 8 show a galvanic cell 1, the electrode stack of which is surrounded by a housing 5. The layers 2, 4 of the electrode stack are releasably connected in a connecting area 7. The clamping devices 9, 9a connect the layers of the electrode stack. The legs of the clamping device 9, 9a are electrically insulated from each other and have in each case one terminal contact 12, 12a. The legs of the clamping devices 9, 9a contact the electro stack. The terminal contacts 12, 12a protrude out of the housing 5. At each of the terminal contacts 12, 12a, one seal is provided. The non-illustrated springs of the clamping device 9 are configured such that the spring constants of the same increasingly soften with increasing temperature. Thus, the force exerted by the clamping devices 9, 9a on the electrode stack decreases with increasing temperature. Alternatively, the springs are made from a material which is increasingly weakened above a predetermined temperature by an additive of the electrolyte. After opening a clamping device 9, 9a or the failing of the same, contacting the electrode stack is interrupted. It is not illustrated here that a clamping device has in particular a lever for releasing. This lever is in particular actuated by an activator. It is not illustrated here that the clamping device is closed by means of a spring-loaded toggle lever. The spring-loaded toggle lever is provided so as to open in particular above a predetermined temperature and/or predetermined pressure.

FIG. 8 shows a galvanic cell having a plurality of spring-loaded clamping devices 9, 9a. They are in particular firmly bonded with a frame element 13. It is not illustrated here that a clamping device 9, 9a is connected in a rotatably movable manner to the frame element 13 and that a closing spring is supported on the frame element 13. The frame element 13 is part of the housing 5 and is in particular connected thereto in a firmly bonded manner. A spring-loaded clamping device compensates in particular thermally caused thickness variations. A force exerted on the electrode stack in particular by an activator results in the stack being displaced out of the clamping device. Thereby, in particular, the contact to the electrode stack is interrupted.

FIG. 9 shows a galvanic cell 1 according to the invention having an anode 2, cathode 3, housing 5 and a sealing area 8. The sealing area 8 has an area which is formed as thin region 14. At a predetermined pressure, the thin region 14 fails and, in particular, the overpressure present in the housing 5 is reduced. Furthermore, the galvanic cell 1 is equipped with different opening devices 15, 15a, 15b which are provided so as to open the housing 5 at predetermined conditions. After opening, the overpressure valve 15a allows a reduction of the pressure difference between the internal pressure of the cell and the environment. Preferably, the housing 5 has a plurality of safety valves 15a which open at different pressure differences. The blade section 15 is arranged at a certain distance from the housing. When the housing 5 expands, an area of the housing 5 reaches the blade section 15. The latter opens the housing 5. Preferably, a plurality of blade sections 15 are arranged at different positions on the housing 4 and/or at different distances therefrom. An opening device 15 can also be formed as tip. A needle 15b is arranged at a distance from the housing 5. The expanded housing 5 contacts the needle 15b which opens the housing 5. Said needle 15b is surrounded by a piece of hose which conveys exiting gases to a condensation cartridge. There, the electrolyte is collected and, if necessary, liquefied. The condensation cartridge can be replaced within the maintenance works. Preferably, a plurality of hose pieces or opening devices is connected to the same condensation cartridge. It is not illustrated that in addition to the electrode stack, the housing also receives a feeder. The feeder is provided for exerting, at least temporarily, a force on the housing. At predetermined conditions, the force exerted on the housing is high enough that the housing fails. Thereby, at least one connecting area is released and associated layers of the electrode stack move away from each other at least in certain areas.

FIG. 10 shows an opening device which is configured as feeder 16. The feeder 15 is made from a composite material which has areas 16a, 16b with different coefficients of thermal expansion. Furthermore, the feeder 16 has a spike 17. Depending on the temperature, the feeder 16c, 16d changes its geometry and, in particular, exerts a force on the non-illustrated housing. According to the invention, the housing fails in particular at a perforation, a weak point or connecting seam and/or is penetrated by a spike.

The above-described possibilities for interrupting the internal electrical contacting of an electrode stack can preferably be combined with a manual or automatic battery emergency switch.

In the meaning of the invention, the above-described possibilities for stapling and clamping an electrode stack to a frame can also be combined with each other. The clamping and/or stapling according to the invention to a frame can also extend over a plurality of electrode stacks which are stapled and/or clamped simultaneously. Likewise, it is also possible to clamp and/or staple only individual separators, electrodes or the arresters thereof.

As a modification of the above-described embodiments, the invention can also be used for spiral wound cells.

1. A galvanic cell (1) comprising a substantially prismatic electrode stack (6), an electrolyte and a housing (5) which is provided to at least partially enclose the electrode stack (6), wherein the electrode stack (6) is designed having multiple layers and comprises at least one anode layer (2), one cathode layer (3) and one separating layer (4), wherein the at least one separator layer (4) is arranged at least partially between an anode layer (2) and a cathode layer (3), and wherein the at least one separator layer (4) at least partially absorbs the electrolyte,
wherein
the at least one anode layer (2), the at least one cathode layer (3) and the at least one separator layer (4) are provided to be releasably connected to each other in at least one connecting area (7, 7a), in particular by means of at least one releasable connecting device (9, 9a, 9b), that upon failing of the releasable connecting area, adjacent layers of the electrode stack move away from each other at least in certain areas.

2. The galvanic cell (1) according to claim 1, characterized in
that the housing (5) rests against the electrode stack (6) at least in certain areas,
that the housing (5) is connected in a sealing area (8) in a firmly bonded manner to the electrode stack (6), and that the housing (5) has at least one thin region (14).

3. The galvanic cell (1) according to claim 2, wherein the at least one releasable connecting area (7, 7a) is provided, or, respectively, the at least one releasable connecting device (9, 9a, 9b) is provided to become released at predetermined conditions.

4. The galvanic cell (1) according to claim 3, wherein the at least one releasable connecting device (9, 9a, 9b) is associated with the housing (5).

5. The galvanic cell (1) according to claim 4, wherein the at least one releasable connecting device (9, 9a, 9b) comprises at least one terminal contact (12, 12a) and a frame element (13), wherein the frame element (13) at least partially encloses the electrode stack (6).

6. The galvanic cell (1) according to claim 5, wherein the housing (5) is associated with at least one opening device (15, 15a, 15b) which is provided to open the housing (5) at predetermined conditions.

7. The galvanic cell (1) according to claim 6, wherein the electrode stack (6) has at least one boundary edge and that the electrode stack (6) is at least partially connected in a releasable manner along said boundary edge, in particular by means of a releasable connecting device (9, 9a, 9b).

8. The galvanic cell (1) according to claim 7, wherein the galvanic cell (1) is associated with at least one measuring device (16) and/or at least one cooling device (11).

9. The galvanic cell (1) according to claim 8, wherein the separator layer (4) is formed with a nonwoven from electrically non-conductive fibers, wherein the nonwoven is coated at least on one side with an inorganic material.

10. The galvanic cell (1) according to claim 9, wherein the galvanic cell (1) comprises at least one means (16) for releasing a releasable connecting area (7, 7a) or a releasable connecting device (9, 9a, 9b).

11. The galvanic cell (1) according to claim 10, wherein the at least one separator consists of a substance-permeable carrier, partially substance-permeable, thus substantially permeable with respect to at least one material and substantially impermeable with respect to at least one other material,
wherein the carrier is coated on at least one side with an inorganic material,
wherein as substance-permeable carrier preferably an organic material is used which is configured as nonwoven fabric,
wherein the organic material comprises a polymer and particularly preferred polyethylene-terephthalate (PET),
wherein the organic material is coated with an inorganic, ion-conductive material which is ion-conductive in a temperature range of −40° C. to 200° C.,
wherein the inorganic, ion-conductive material is at least one compound from the group of oxides, phosphates, sulfates, titanates, silicates, aluminosilicates of at least one of the elements Zr, Al, Li, in particular zirconium oxide,
and wherein the inorganic, ion-conductive material has particles with a largest diameter of less than 100 nm.

12. A method for operating a galvanic cell (1) comprising an electrode stack (6) which is designed having multiple layers and has at least one anode layer (2), one cathode layer (3) and one separator layer (4) which are releasably connected to each other in at least one connecting area (7, 7a), by means of at least one releasable connecting device (9, 9a, 9b), wherein at least one connecting area (7, 7a) or one connecting device (9, 9a, 9b) are released at predetermined conditions in such a manner that adjacent layers of the electrode stack move away from each other at least in certain areas.

13. The method according to claim 12 for operating a galvanic cell (1) comprising a housing (5) and at least one opening device (15, 15a, 15b), wherein the at least one opening device opens the housing (5) at predetermined conditions.
